(19) United States
(12) Patent Application Publication
(10) Pub. No.: US 2003/0107575 A1
(43) Pub. Date: Jun. 12, 2003

(54) Customer activity tracking system and method

(76) Inventor: Andrew John Cardno, Wellington (NZ)

Correspondence Address: David E. Bruhn, DORSEY & WHITNEY LLP, Suite 1500, 50 South Sixth Street, Minneapolis, MN, 55402-1498, US

(21) Appl. No.: 10/338,259

(22) Filed: Jan. 8, 2003

Related U.S. Application Data
(63) Continuation of application No. PCT/NZ01/00138, filed on Jul. 10, 2001.

(30) Foreign Application Priority Data
Jul. 10, 2000 (NZ) 505662

(51) Int. Cl. G06T 11/20

(52) U.S. Cl. 345/440

(57) ABSTRACT

A data visualisation system including a data value memory in which is maintained a finite set of data values, a display arranged to display a representation of each data value centered on respective data points, a plurality of the data points positioned in a substantially circular arrangement, and a contour generator arranged to generate and display a contoured representation around each data point such that each data point is displayed as a local maximum. A data visualisation computer program and data visualisation method are encompassed.

### PRIORITY CLAIM

This application is a Continuation of International Patent Application No. PCT/NZ01/00138, filed on Jul. 10, 2001, which claims priority to New Zealand Patent Application No. 505662, filed on Jul. 10, 2000, both of which are incorporated herein by reference. International Patent Application PCT/NZ01/00138 was published in English under PCT Article 21(2).

### FIELD OF INVENTION

The invention relates to a data visualisation system and method and more particularly relates to a customer website activity tracking system and method.

### BACKGROUND TO INVENTION

It is becoming increasingly common for merchants to operate web sites as part of their business. To compete effectively, it is necessary for a merchant to be able to identify and action information collected from the use that is made of these web sites. The task of identifying this hidden information has proved very difficult for merchants.

It would be very useful for a merchant to have the collected data presented in a graphical manner, particularly where the data is to be displayed to a non-technical audience. It would also be beneficial for a merchant to formulate different queries for the collected data without requiring technical knowledge.

### SUMMARY OF INVENTION

In broad terms in one form the invention comprises a data visualisation system comprising a data value memory in which is maintained a finite set of data values; a display arranged to display a representation of each data value centered on respective data points; and a contour generator arranged to generate and display a contoured representation around each data point such that each data point is displayed as a local maximum.

In a further preferred form the invention comprises a data visualisation system comprising a data value memory in which is maintained a finite set of data values; a display arranged to display a representation of each data value centered on respective data points; and a contour generator arranged to generate and display one or more contour lines around each data point, each contour line representing data values which are less than the data value of the data point around which the contour line is displayed.

In another preferred form the invention comprises a data visualisation system comprising a data value memory in which is maintained an interaction database of interaction data representing interactions between customers and merchants; a retrieval device arranged to retrieve from the interaction database data representing interactions between customers and merchants and to construct a finite set of data values from the retrieved data; and a display arranged to display a graphical representation of at least one merchant and to superimpose a contoured representation of the data values on the graphical representation of the merchant, such that each data value is displayed as local maximum.

In another preferred form the invention comprises a method of data visualisation comprising the steps of maintaining in a data value memory a finite set of data values; displaying a representation of each data value centered on respective data points; and generating and displaying a contoured representation around each data point such that each data point is displayed as a local maximum.

In a further preferred form the invention comprises a method of data visualisation comprising the steps of maintaining in a data value memory a finite set of data values; displaying a representation of each data value centered on respective data points; and generating and displaying one or more contour lines around each data point, each contour line representing data values which are less than the data value of the data point around which the contour line is displayed.

In yet another preferred form the invention comprises a method of data visualisation comprising the steps of maintaining in an interaction database interaction data representing interactions between customers and merchants; retrieving from the interaction database data representing interactions between customers and merchants; constructing a finite set of data values from the retrieved data; displaying a graphical representation of at least one merchant; and superimposing a contoured representation of the data values on the graphical representation of the merchant, such that each data value is displayed as a local maximum.

In a further preferred form the invention comprises a data visualisation computer program which enables maintaining in a data value memory a finite set of data values; displaying a representation of each data value centered on respective data points; and generating and displaying a contoured representation around each data point such that each data point is displayed as a local maximum.

In a further preferred form the invention comprises a data visualisation computer program which enables maintaining in a data value memory a finite set of data values; displaying a representation of each data value centered on respective data points; and generating and displaying one or more contour lines around each data point, each contour line representing data values which are less than the data value of the data point around which the contour line is displayed.

In yet a further preferred form the invention comprises a data visualisation computer program which enables maintaining in an interaction database interaction data representing interactions between customers and merchants; retrieving from the interaction database data representing interactions between customers and merchants; constructing a finite set of data values from the retrieved data; displaying a graphical representation of at least one merchant; and superimposing a contoured representation of the data values on the graphical representation of the merchant, such that each data value is displayed as a local maximum.

In yet a further preferred form the invention comprises a data visualisation system comprising a data value memory in which is maintained a finite set of data values; a display arranged to display a representation of each data value centered on respective data points, a plurality of the data points positioned in a circular arrangement; and a relationship generator arranged to generate and display relationships between one or more pairs of the data points positioned in a circular arrangement.

In a further preferred form the invention comprises a method of data visualisation comprising the steps of maintaining in a data value memory a finite set of data values; displaying a representation of each data value centered on respective data points, a plurality of the data points positioned in a circular arrangement; generating and displaying relationships between one or more pairs of the data points positioned in a circular arrangement.

In a further preferred form the invention comprises a data visualisation computer program which enables maintaining in a data value memory a finite set of data values; displaying a representation of each data value centered on respective data points, a plurality of the data points positioned in a circular arrangement; generating and displaying relationships between one or more pairs of the data points positioned in a circular arrangement.

### BRIEF DESCRIPTION OF THE FIGURES

Preferred forms of the customer activity tracking system and method will now be described with reference to the accompanying Figures in which:

FIG. 1 shows a block diagram of an Internet-based system in which the invention may be implemented;

FIG. 2 shows the preferred system architecture of hardware on which the present invention may be implemented;

FIG. 3 shows an interaction between a customer and a merchant and the migration, retrieval and display of data obtained from the interaction;

FIG. 4 shows a typical representation generated and displayed by the invention as showing a customer provenance map and merchant store representation;

FIG. 5 shows another representation generated and displayed by the invention as showing the site map of a merchant web site;

FIG. 6 shows the site map of FIG. 5 configured to identify traffic flow; and

FIG. 7 shows a further representation generated and displayed by the invention showing the site map of a merchant web site;

FIGS. 8 and 9 are variations of the representation of FIG. 7;

FIG. 10 is a representation of a merchant web site with contoured data included; and

FIG. 11 shows a web site usage profile generated and displayed by the invention.

### DETAILED DESCRIPTION OF PREFERRED FORMS

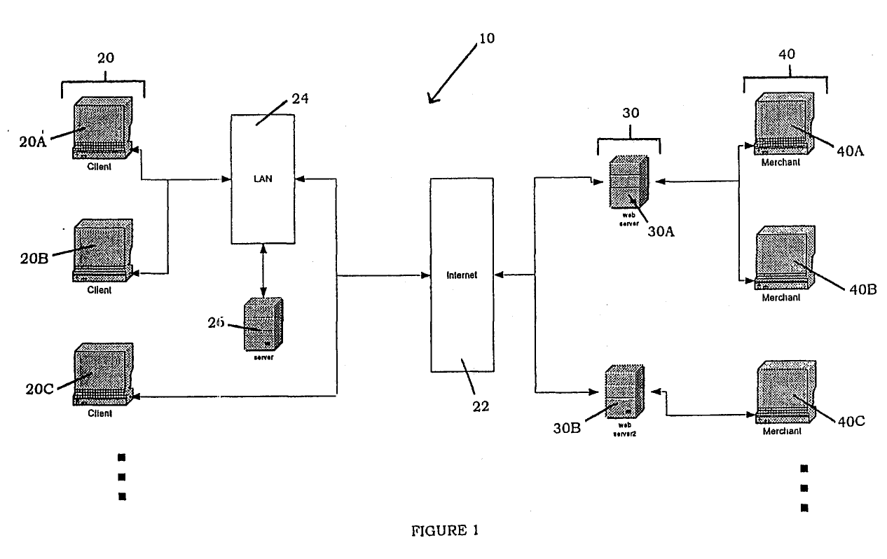

FIG. 1 illustrates a block diagram of the preferred Internet-based system 10 in which the present invention may be implemented. The system includes one or more clients 20, for example clients 20A, 20B and 20C, which each may comprise a personal computer or workstation which will be described below. Each client 20 is interfaced to the Internet 22. As shown in FIG. 1, each client 20 could be connected directly to the Internet with a suitable dial-up connection or could be connected through a local area network or LAN. Client 20C is shown as connected to the Internet 22 with a dial-up connection. Clients 20A and 20B, on the other hand, are connected to a network 24, such as a local area network or LAN. The network 24 could be connected to a suitable network server 26 and communicate with the Internet 22 as shown.

The system 10 also includes one or more web servers 30, for example web server 30A and 30B. Each web server 30 is connected to the Internet 22 as shown in FIG. 1. Each web server 30 preferably comprises a personal computer or workstation operating under the control of suitable software. Connected to web servers 30 are one or more merchant computers or workstations 40, for example merchant 40A, 40B and 40C. Two or more merchants could be connected to the same web server as is the case with merchant 40A and merchant 40B both connected to web server 30A. Alternatively, merchant 40C, for example, could be connected to dedicated web server 30B.

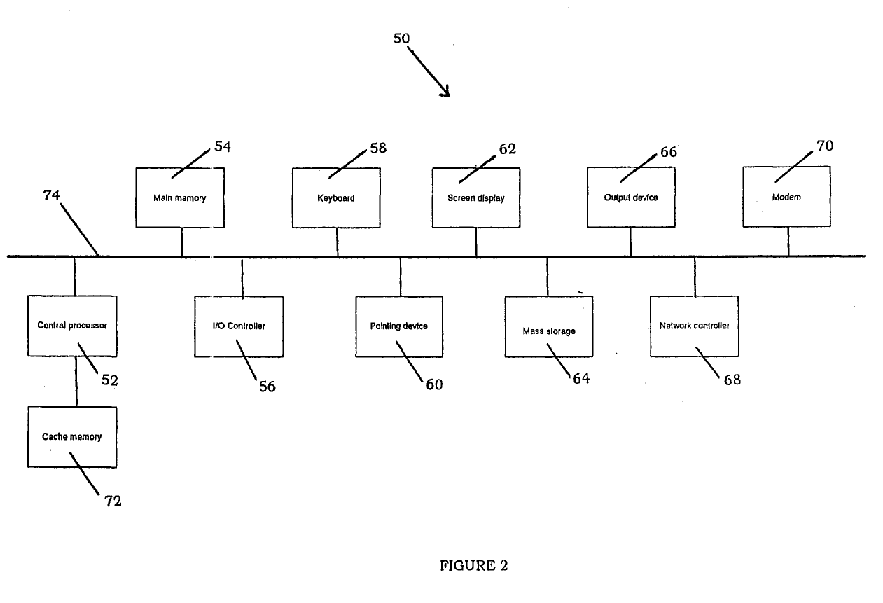

FIG. 2 shows the preferred system architecture of a client 20, web server 30 or merchant 40 computer or workstation The computer system 50 typically comprises a central processor 52, a main memory 54, an input/output controller 56, a keyboard 58, a pointing device 60 for example a mouse, a display or screen device 62, a mass storage 64, for example a hard disk, floppy disk or optical disc, and an output device 66 for example a printer. The computer system 50 could also include a network interface card or controller 68 and/or a modem 70. The processor 52 could also include or be interfaced to a cache memory 72 which could be arranged as an on-chip cache or external cache. The individual components of system 50 could communicate through a system bus 74.

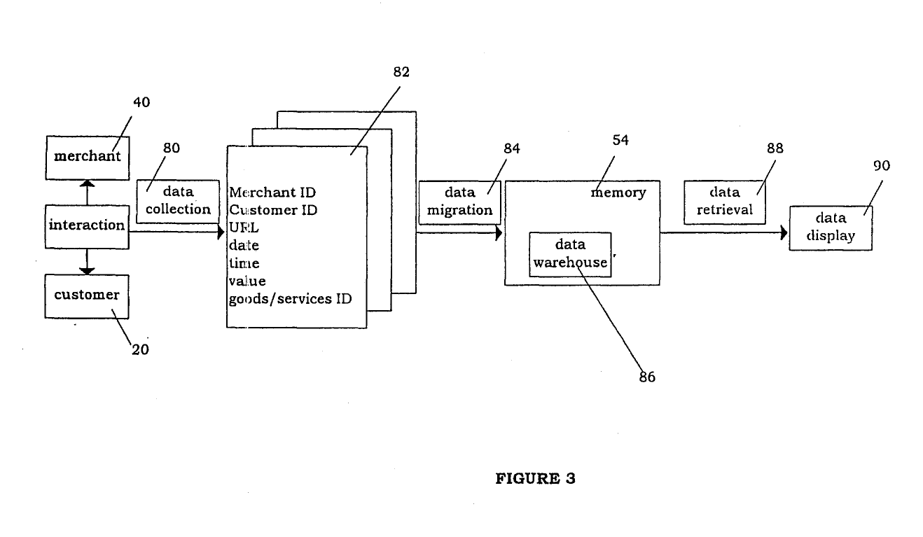

Referring to FIG. 3, a customer on client workstation 20 interacts with a merchant 40. The merchant 40 could include an individual, a company or organisation and will typically operate a web site or other electronic medium through which customer 20 purchases goods or services. The merchant may alternatively operate an on-line casino, gambling or other gaming facility. The merchant could also offer transport and delivery, financial or banking services.

Customer 20 could include an individual, a company or organisation. The customer could be a purchaser of goods or services from the merchant or could simply be visiting a web site operated by the merchant. An interaction between a customer 20 and a merchant 40 could be initiated by either the customer or by the merchant. As the customer 20 interacts with merchant 40, the interaction generates interaction data which is collected as indicated at 80. A typical record of collected interaction data is shown at 82. The record could include, for example, a merchant identifier. This merchant identifier could be used to identify a particular merchant and could comprise the universal resource locator (URL) of a web site operated by the merchant, or an Internet protocol (IP) address for the merchant. The record 82 could also include a customer identifier. The customer identifier could include the IP address or other network address of the customer client 20. The customer identifier could alternatively comprise a character string assigned to the customer by the merchant during a registration process with a facility for the customer to supply a user name and password to initiate an interaction in the known way.

The record 82 could also include the universal resource locator (URL) of a web page visited by the customer 20 during an interaction. The record 82 could also include other data such as the date and/or time at which the interaction between the customer and the merchant took place, the cash value of any transaction if applicable, and a goods/services identifier where a transaction has taken place. It is envisaged that each new URL visited by a customer, for example each new page visited in a merchant web site, generates a new interaction record. By retrieving and sorting these records by date and time, it is possible to calculate the number of customers visiting a particular web site and the average time spent at a particular web page or page cluster, as will be more particularly described below.

The interaction data is migrated to memory 54 of a suitable personal computer or workstation 50 as indicated at 84. Preferably the interaction data is stored in a data repository for example a data warehouse 86. It is envisaged that the data repository may alternatively comprise a single database, a collection of databases, or a data mart The data warehouse could also include data from other sources, for example, census data, data from a merchant-customer database, data from a merchant loyalty programme and/or promotion data held by a merchant.

The system retrieves data representing interactions between customers and merchants from the data warehouse 86 as indicated at 88. Preferably the system permits a user to specify the data to be retrieved, as will be more particularly described below.

After data retrieval, the system displays the data as indicated at 90, preferably as a graphic representation of the data on a screen display 62 of a suitable workstation. The representation of the data preferably includes animated visualisations (AVIs) or still images (stills) of web site usage by customers and the provenance or origin of those customers over the course of a trading period.

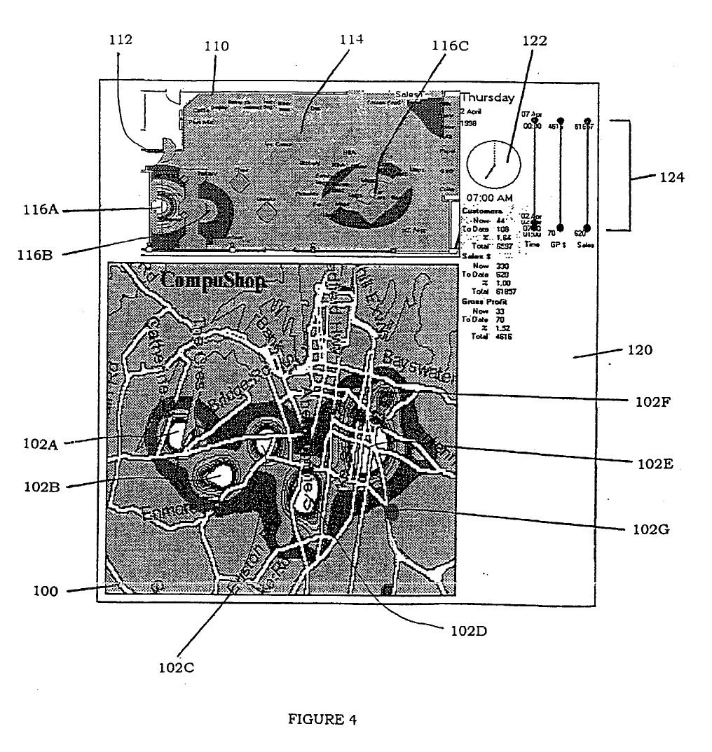

FIG. 4 shows a typical representation generated by the system. The display could include a customer provenance window 100. The preferred customer provenance window displays a graphical spatial representation in the form of a topographical map. The map is arranged to show the origin of customers interacting with a particular merchant. It will be appreciated that the scale of the map could be altered, depending on the customer base under consideration. The map could include a detailed map, such as that shown in FIG. 4 showing suburbs in a particular city, could alternatively show individual cities in a particular country, or could be a global map showing all countries.

The system may present the data to the user based on one of a number of key performance indicators (KPIs) which could include total sales, gross profit, net profit, gross margin return on inventory investment (GMROII), net margin return on inventory investment (NMROII), return on net asset (RONA), loyalty sales data, time spent viewing a particular web site or page and/or a web page visitation percentage. Each representation could show for example a combination of number of customers, the number of sales and gross profit as is the case in FIG. 4.

The preferred representation of data displays a particular value at a finite set of points in the representation, for example points 102A, 102B, 102C, 102D, 102E, 102F and 102G in FIG. 4. The areas of representation around each data point are shown as a series of contour lines. The nature of the contours for each data point are preferably represented to gradually drop off or fall away from each data point Each data point could be represented by x and y co-ordinates indicating the relevant position of each data point in the representation. Each data point could also have a z value representing the height or magnitude of the data point. This z value could indicate, for example, the time spent viewing a particular website and/or web page, or the revenue generated from a particular web page. The contour lines represent z data values which are less than the data value of the data point around which the contour lines are displayed. In this way, each data value is centered on a data point. Each data point is displayed as a local maximum as surrounding values drop off or fall away around each point.

This contoured method of representing data values is more particularly described in our patent specification WO 00/77862 to Compudigm International Limited filed on Jun. 14, 2000 entitled “Data Visualisation System and Method” which is incorporated by reference. The data value of each data point represents the apex of a bell-shaped curve. As x and y values in the representation are increased or decreased, the z value at the new position in the presentation will change.

The customer provenance map 100 shown in FIG. 4 illustrates that the customers contributing to the largest KPI values, have a provenance or point from which they interact with a particular merchant which is centred on point 102E. Customers contributing to the lowest KPI values for the merchant have a provenance at point 102G. It will be readily inferred from such a representation that the most valuable customers are based around point 102E.

As described above with reference to FIG. 3, each interaction record 82 includes a customer identifier. This customer identifier could be linked to a physical address, within the requirements of any privacy restrictions, provided to a merchant by a customer at the time of registration or log-on. Alternatively, a geographic location could be inferred from the interaction itself. For example, a client workstation used by a customer may use a particular network or Internet address from which a country code or indicator could be extracted. This would at least provide customer provenance data to country level.

Referring to FIG. 4, the system could also generate and display a representation of the merchant as indicated at 110. Where a merchant offers a range of goods or services, the representation 110 could comprise a graphical spatial representation of a “virtual store”. The virtual store plan could show virtual positions of a door 112, a service counter and one or more shelves 114 on which products are displayed. Where a merchant operates in a commercial premises or store in conjunction with a web site, it is envisaged that the representation 110 could comprise the actual graphical spatial representation of the store. Where a merchant operates from two or more retail stores, the graphical representation could include spatial representations of each store and could also include a large scale map of the geographical area in which the merchants stores are located.

The representation 110 preferably shows distinct product types spaced over the representation. As described above with reference to FIG. 3 each interaction record 82 may include goods/services ID which could be grouped into product types. Each product type or grouping in the representation could represent a data point which is contoured in the same way as the customer provenance map 100 described above. Typical store plan data points are indicated at 116A, 116B and 116C. KPI values at individual points 116A, 116B and 116C are displayed as peaks, and values of areas between these data points are shown as contours in the same way as that described above.

The display could also include a progress bar as indicated at 120. The progress bar 120 could include an analogue time display 122 and date information for a particular visualisation. The presentation could also display one or more KPIs, for example the number of customers, number of sales and gross profit for a particular visualisation and also display totals, cumulative totals and cumulative percentages.

It is envisaged that the representation shown in FIG. 4 could be presented to a user as a still image or still. Alternatively, the user could be presented with a series of time consecutive visualisations forming an animated visualisation or AVI. The analogue time display 122 would show the user the progress of the AVI. It is also envisaged that the main screen could also include progress bars indicated at 124 which present a sliding scale of cumulative KPI totals to a user as the animation progresses.

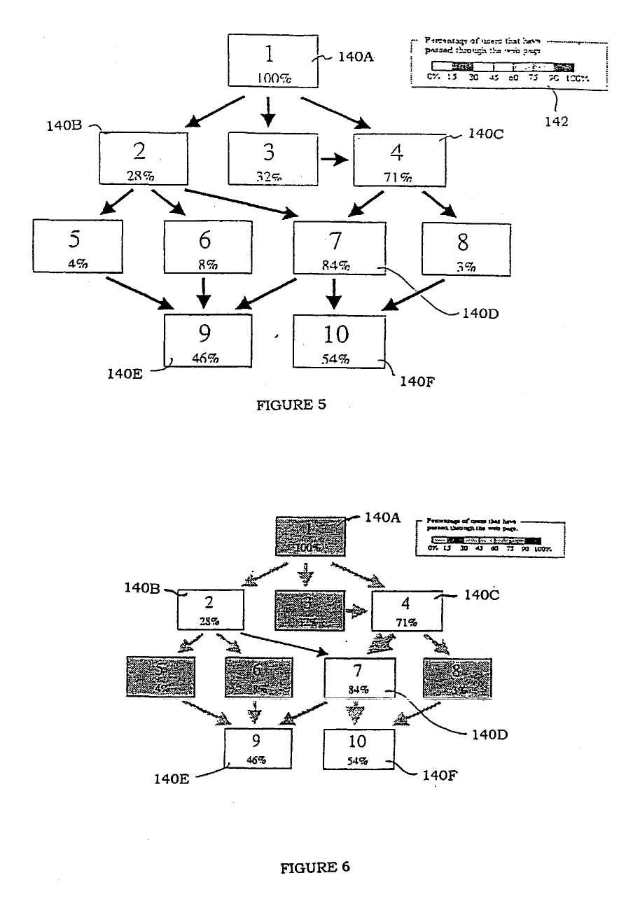

The system is preferably also arranged to display a graphical site map of a merchant's web site. FIG. 5 illustrates one preferred form representation. Web site pages or page clusters are indicated, for example, as boxes 140A, 140B, 140C, 140D, 140E and 140F. Each box is preferably shown with a page or page cluster number and a percentage representing the percentage of users visiting the web site who have viewed the particular page or page cluster.

For example, 100% of users visiting the web site have visited the home page shown as 140A. Web page 140B, which is accessible from web page 140A, has been visited by 28% of users. Web page 140C, which is accessible from web page 140A, has been visited by 71% of users.

By retrieving a set of records from the interaction database using a customer identifier as a key, and then sorting these records by date and time, the usage of a web site by an individual customer can be tracked and displayed in accordance with the invention.

In a preferred form, the representation shown in FIG. 5 could have superimposed on it a representation of the data retrieved from the interaction database in the form of a series of ripple contours, with those web pages attracting high usage being contoured as peaks. It will be appreciated that the KPI on which the representation is contoured could include any one or more of the KPIs discussed above, for example, total sales, gross profit, net profit and the like.

As shown in FIG. 5, the user could also be presented with a legend 142 for shading relating to particular percentage values of visitation for each web page or page cluster.

Referring to FIG. 6, the system may also be arranged to show traffic flow associated with a nominated page or page cluster. The user may be permitted to click for example on page representation 140D in the display, causing this page to be highlighted. Contributing pages 140B and 140C are highlighted as are destination pages 140E and 140F. The remaining web pages are greyed out. Customer traffic flow between web pages is preferably shown proportionally by the size of linking arrows. For example, the arrow linking web page 140B to 140D is thinner than the arrow linking web page 140C to 140D, indicating that web traffic from web page 140C to 140D is greater than web traffic from web page 140B to 140D. It is envisaged that the colour of the arrows could also be varied to represent traffic flow.

The system is also preferably arranged to calculate and display web site usage patterns. By retrieving a set of records from the interaction database using a customer identifier as a key, and sorting the records by date and time, the system can calculate how long a particular customer spends viewing a particular web page or URL by calculating the difference in time between successive interaction records involving different web pages or URLs.

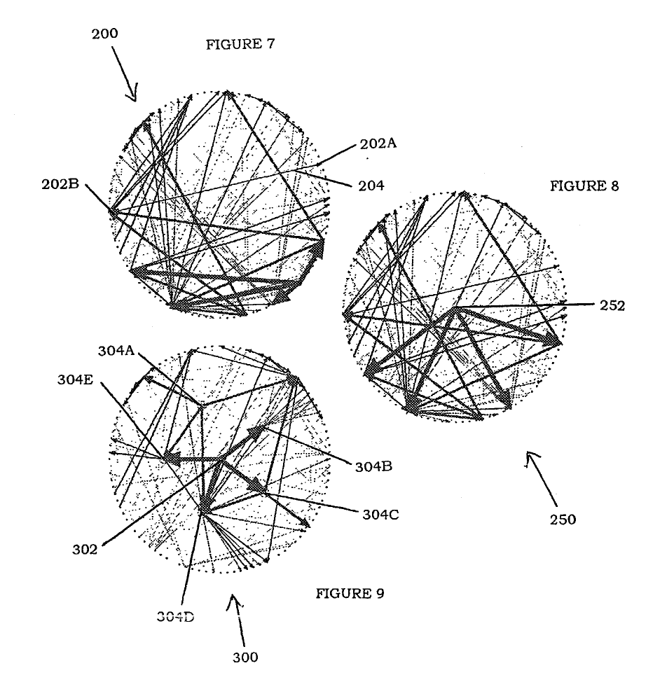

FIG. 7 illustrates a further preferred form representation 200 of a graphical site map of a merchant's web site. The representation 200 is formed by representing each web site page as a data point shown as a dot or icon, for example 202A and 202B, substantially equally spaced around the circumference of a circle or at least in a circular arrangement.

In one form of the invention, a relationship generator could comprise a computer-implemented software program programmed to generate and display relationships between one or more pairs of the data points positioned in the circular arrangement. For example, the relationship generator generates and displays relationship 204 between data points 202A and 202B. Each relationship could represent, for example, web traffic between website pages. In FIG. 7, for example, there is a degree of web traffic from the website page represented by data point 202B to the website page represented by data point 202A. The direction of web traffic is indicated by a directional arrow. It is envisaged that the relationship generator could also display an indicator of web traffic magnitude between pairs of website pages. This indicator of website magnitude could include line thickness. For example, a thicker line or arrow between two data points could represent greater web traffic than a thinner line.

The size, colour, style and/or stipple of each arrow could be varied to show direction and magnitude of traffic flow between the respective web pages, or any other KPI described above, for example, total sales, gross profit, net profit, gross margin return on inventory investment (GMROII), net margin return on inventory investment (NMROII), return on net asset (RONA), loyalty sales data, time spent viewing a particular web site and/or a web page visitation percentage.

The relationship between respective web pages could be one-to-one, one-to-many or many-to-one. The visual images could be filtered to only show some relationships/graphics. The representation could show, for example, only relationships between nodes in one direction. The representations could also be segmented to emphasise related page clusters and other information.

FIG. 8 shows another preferred representation 250 in which the object or web page having the largest value of a specified KPI becomes the central object in the summary image as indicated at 252 in representation 250. A web page having the largest value of a specified KPI could be displayed as a first data point in the centre of a circle. The remaining data points could be displayed in a circular arrangement around the first data point.

The direction and magnitude of traffic between website pages is also represented in FIG. 8 in the same manner as FIG. 7.

As shown in FIG. 9, a further representation 300 could show the largest value KPI in the centre as indicated at 302. Further high value objects could be spaced equidistant from the centre shown at 304A, 304B, 304C, 304D and 304E. These objects 304 could represent a second tier of KPI values. The criteria for inclusion in this second tier could be user defined, and could include the next X objects, for example X=4, that have the largest volume of some KPI, or a volume above a predefined threshold.

Data point 302 having the largest KPI value is positioned in the centre of the circle. The user could specify a predefined KPI threshold and display all data points having data values exceeding this predefined threshold in a circular arrangement around data point 302. Examples in FIG. 9 are 304A, 304B, 304C, 304D and 304E. Each of the data points 304 is preferably positioned at substantially equal distances from data point 302.

The remaining data points not exceeding the predefined threshold are presumably of less relevance to the user and are positioned around the circumference of the larger circle. The remaining data points are preferably spaced a greater distance from data point 302 than each of data points 304.

It is envisaged that the threshold criteria will vary according to the nature of the data being compared. For example, data points 304 could be determined if they exceed a predefined threshold value or if they are less than a predefined threshold, depending on whether a low or high data value is of interest to the user.

The representations could include three, four or more tiers as required by the user. The representations could have their hierarchy imposed on them by the user specifying that a particular node be the central node.

In each of FIGS. 8, 9 and 10, a plurality of data points are arranged in a substantially circular arrangement.

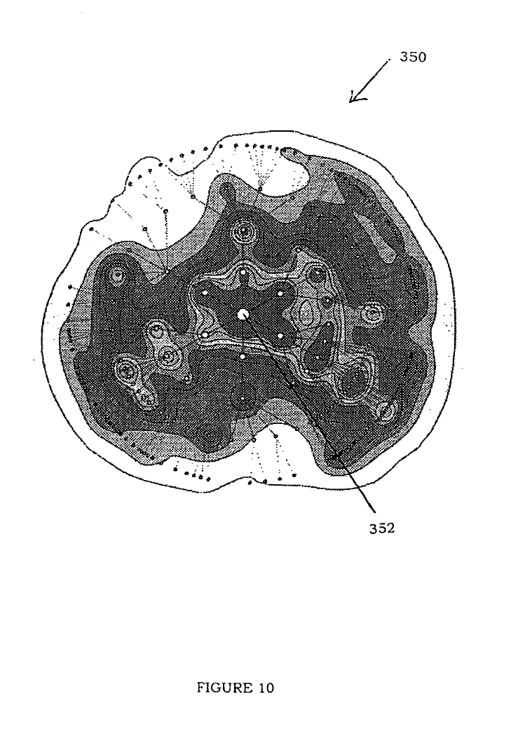

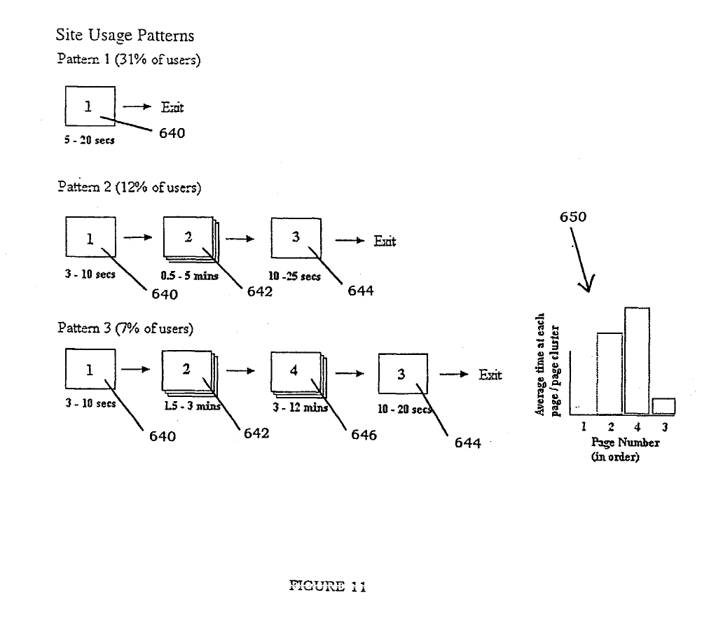

FIG. 10 shows a further preferred form representation 350 in which the largest value KPI object is shown as the central object 352, with several tiers of objects radiating outwardly from the central object. Links could be shown connecting objects, and these links could be displayed with or without directional arrows.

The preferred representation 350 displays KPI values as contoured representations similar to the representations described above with reference to FIG. 4. The value at each web site object is preferably represented as a contoured representation, having a defined value at the centre of the point with values around the representation dropping away gradually between data points. Data points with large values, for example 352, are represented as higher peaks than other data points with lower values.

By compiling usage patterns for individual customers, the system can develop and display a profile of site usage, for example as shown in FIG. 11 in which a merchant operates a web site having four web page or page clusters. These could include for example a front page or menu 640, a second web page 642 which elicits from the user a customised shopping list, a third web page 644 providing delivery and/or payment options, and a fourth web page 646 arranged to display specials to a user and permit the user to select one or more of these specials.

The system may recognise several patterns in site usage. For example, pattern 1 could comprise 31% of all users who spend between 5 and 20 seconds viewing web page 640 and then exit Referring to pattern 2, 12% of users could spend between three and ten seconds on web page 640, between 0.5 and 5 minutes on web page 642, between 10 and 25 seconds on web page 644 and then exit. Pattern 3 could comprise 7% of users who spend 3 to 10 seconds on web page 640, 1.5 to 3 minutes on web page 642, spend 3 to 12 minutes on web page 646, spend 10 to 20 seconds on web page 644 and then exit

The system could recognise these patterns of repeated web page and page cluster visitation and usage. It could rank these patterns based on the percentage of web site visitors that the pattern includes, and display details such as the pattern percentage, the average time spent at each page or page cluster as indicated at 650, and the resultant KPIs of different usage patterns. The system could display for example a finite number of most common usage patterns, the number being defined by the user.

The system could also be arranged to record and display further patterns of use of particular web pages. It is envisaged that the interaction database 82 could be arranged to store further interaction data, for example the areas of a web page from which a particular user makes selections or into which a user types data, the areas to which a mouse pointer operated by a user is tracked and clicked while in the web site, known as the click source, and also the URL(s) of the source web page visited by a user prior to visiting the web page under consideration, and/or the destination web page visited by the user after visiting the web page under consideration.

The preferred system displays to the user several options for the retrieval and display of data. The system may include, for example, a visualisation Wizard implemented in a Microsoft Windows environment. It is envisaged that known equivalents may replace the Wizard when the system is implemented in different environments such as Apple, Sun Microsystems, or Unix/Linux environments. The preferred wizard enables a user to create a synchronised pair of AVIs or stills, together with associated web site visitation and usage. The preferred wizard also enables a visualisation to be tailored to show a specific web site usage by requiring selections to be made for:

Geographic area

Customer profile or snapshot

The KPI that the customer provenance map will contour

Labels for the customer provenance map

The KPI that the web site usage map will contour

Labels for the web site usage map

KPI progress bars (if any) are included

What published KPI statistics (if any) are included

Labels for the web page usage diagram

Shading for the web page usage diagram

AVI start and finish dates and times and scheduling options

AVI frame frequency, for example a new frame every 5 minutes, 10 minutes, 30 minutes, etc

Name description and cataloguing options

The system may also be arranged to perform customer loyalty and marketing functions. The invention could provide the user with several options for generating mailing lists of web site users according to a particular criteria. For example, the system could generate a mailing list for those customers who have used a site, or those who fit a particular pattern of site usage as described above. The system could identify regular users of the site, calculate an approximate frequency of site usage, identify trends of increasing or decreasing usage across subsequent visits, and/or produce a list of those whose site usage changes for some reason.

For example, the system could identify weekly shoppers who miss a week's order, customers who browse the “weekly specials” page, customers who have started to visit a particular web page after being included in a promotional mail out, and whether the customer is making purchases as a result. The system could also be arranged to assemble mailing lists of those users who make heavy usage of help pages.

It will be appreciated that a merchant operating a web site is vulnerable to attacks from what may appear to be genuine customers. These hackers often attempt to gain unauthorised access to a web site and either change the web site in some fashion by altering the text displayed on the web site, installing unauthorised computer programs or software on the web site, or retrieving data or computer programs from a web site without authorisation from the merchant.

Using the interaction database 82 described above with reference to FIG. 3, supplemented with activity logs which routinely capture and store activity on a web site, the system could compile and display profiles of unauthorised customers. The system could display, for example, a customer provenance window such as that described above with reference to FIG. 4.

It is envisaged that the system could build weekly or monthly reports listing any identified hacker attempts and details of these attempts with representations summarising their provenance or locations. In this way, a merchant could identify and build a profile of hacker activity directed to their organisation, enabling the merchant to identify individual hackers, pinpoint their own security weaknesses and to develop strategies to counter unauthorised activity.

In summary, the system and method of the invention permits a user to examine a visualisation of interaction data between customers and merchants, particularly visualisations of customers visiting a web site operated by a merchant. Data visualisations, in particular the animated visualisations described above, are a useful complement to other reporting tools, such as charts and graphs.

Using the system and method described above, a user may make sense of and obtain useful data from a data warehouse without requiring technical knowledge. For example, the user may identify optimal ordering of web page links on a merchant web site and select the most desirable ordering and positioning of these links. The user may also identify correlations between sales of different goods or services and may also identify the effectiveness of loyalty programmes and other incentive schemes.

The foregoing describes the invention including preferred forms thereof. Alterations and modifications as will be obvious to those skilled in the art are intended to be incorporated within the scope hereof.

1. A data visualisation system comprising:
a data value memory in which is maintained a finite set of data values;
a display arranged to display a representation of each data value centered on respective data points; and
a contour generator arranged to generate and display a contoured representation around each data point such that each data point is displayed as a local maximum.

2. A data visualisation system comprising:
a data value memory in which is maintained a finite set of data values;
a display arranged to display a representation of each data value centered on respective data points; and
a contour generator arranged to generate and display one or more contour lines around each data point, each contour line representing data values which are less than the data value of the data point around which the contour line is displayed.

3. A data visualisation system as claimed in claim 1 or claim 2 further comprising:
a memory in which is maintained an interaction database of interaction data representing interactions between customers and merchants; and
a retrieval device arranged to retrieve from the interaction database data representing interactions between customers and merchants, to construct the finite set of data values from the retrieved data and to store the data values in the data value memory.

4. A data visualisation system comprising:
a data value memory in which is maintained an interaction database of interaction data representing interactions between customers and merchants;
a retrieval device arranged to retrieve from the interaction database data representing interactions between customers and merchants and to construct a finite set of data values from the retrieved data; and
a display arranged to display a graphical representation of at least one merchant and to superimpose a contoured representation of the data values on the graphical representation of the merchant, such that each data value is displayed as local maximum.

5. A data visualisation system as claimed in claim 3 or claim 4 wherein the merchant operates from one or more websites which are accessed by customers over a computer network, each data point representing a merchant website page.

6. A data visualisation system as claimed in any one of the preceding claims wherein the plurality of the data points are positioned in a circular arrangement.

7. A method of data visualisation comprising the steps of:
maintaining in a data value memory a finite set of data values;
displaying a representation of each data value centered on respective data points; and
generating and displaying a contoured representation around each data point such that each data point is displayed as a local maximum.

8. A method of data visualisation comprising the steps of:
maintaining in a data value memory a finite set of data values;
displaying a representation of each data value centered on respective data points; and
generating and displaying one or more contour lines around each data point, each contour line representing data values which are less than the data value of the data point around which the contour line is displayed.

9. A method of data visualisation as claimed in claim 7 or claim 8 further comprising the steps of:
maintaining in a memory an interaction database of interaction data representing interactions between customers and merchants;
retrieving from the interaction database data representing interactions between customers and merchants;
constructing the finite set of data values from the retrieved data; and
storing the data values in the data value memory.

10. A method of data visualisation comprising the steps of:
maintaining in an interaction database interaction data representing interactions between customers and merchants;
retrieving from the interaction database data representing interactions between customers and merchants;
constructing a finite set of data values from the retrieved data;
displaying a graphical representation of at least one merchant; and
superimposing a contoured representation of the data values on the graphical representation of the merchant, such that each data value is displayed as a local maximum.

11. A method of data visualisation as claimed in claim 9 or claim 10 wherein the merchant operates from one or more websites which are accessed by customers over a computer network, each data point representing a merchant website page.

12. A method of data visualisation as claimed in any one of claims 7 to 11 further comprising the step of positioning the plurality of data points in a circular arrangement.

13. A data visualisation computer program which enables:
maintaining in a data value memory a finite set of data values;
displaying a representation of each data value centered on respective data points; and
generating and displaying a contoured representation around each data point such that each data point is displayed as a local maximum.

14. A data visualization computer program which enables:
maintaining in a data value memory a finite set of data values;
displaying a representation of each data value centered on respective data points; and
generating and displaying one or more contour lines around each data point, each contour line representing data values which are less than the data value of the data point around which the contour line is displayed.

15. A data visualisation computer program as claimed in claim 13 or claim 14 which further enables:
maintaining in a memory an interaction database of interaction data representing interactions between customers and merchants;
retrieving from the interaction database data representing interactions between customers and merchants;
constructing the finite set of data values from the retrieved data; and
storing the data values in the data value memory.

16. A data visualisation computer program which enables:
maintaining in an interaction database interaction data representing interactions between customers and merchants;
retrieving from the interaction database data representing interactions between customers and merchants;
constructing a finite set of data values from the retrieved data;
displaying a graphical representation of at least one merchant; and
superimposing a contoured representation of the data values on the graphical representation of the merchant, such that each data value is displayed as a local maximum.

17. A data visualisation computer program as claimed in claim 15 or claim 16 wherein the merchant operates from one or more websites which are accessed by customers over a computer network, each data point representing a merchant website page.

18. A data visualisation computer program as claimed in any one of claims 13 to 17 wherein the merchant operates from one or more websites which are accessed by customers over a computer network, each data point representing a merchant website page.

19. A data visualisation computer program as claimed in any one of claims 13 to 18 embodied on a computer-readable medium.

20. A data visualisation system comprising:
a data value memory in which is maintained a finite set of data values;
a display arranged to display a representation of each data value centered on respective data points, a plurality of the data points positioned in a circular arrangement; and
a relationship generator arranged to generate and display relationships between one or more pairs of the data points positioned in a circular arrangement.

21. A data visualisation system as claimed in claim 20 wherein the display is arranged to display a first data point having the highest data value and to display the remaining data points in a circular arrangement around the first data point.

22. A data visualisation system as claimed in claim 20 wherein the display is arranged to display a first data point having the highest data value, to display a plurality of data points having data values exceeding a predefined threshold in a circular arrangement around and at substantially equal first distances from the first data point, and to display the remaining data points in a circular arrangement around and at substantially equal second distances from the first data point; the second distances greater than the first distances.

23. A data visualisation system as claimed in any one of claims 20 to 22 wherein each data point represents a website page, the relationship generator arranged to display relationships representing web traffic between one or more pairs of website pages.

24. A data visualisation system as claimed in claim 23 wherein the relationship generator is arranged to display an indicator of web traffic magnitude between pairs of website pages.

25. A method of data visualisation comprising the steps of:
maintaining in a data value memory a finite set of data values;
displaying a representation of each data value centered on respective data points, a plurality of the data points positioned in a circular arrangement;
generating and displaying relationships between one or more pairs of the data points positioned in a circular arrangement.

26. A method of data visualisation as claimed in claim 25 further comprising the steps of displaying a first data point having the highest data value; and displaying the remaining data points in a circular arrangement around the first data point.

27. A method of data visualisation as claimed in claim 25 further comprising the steps of:
displaying a first data point having the highest data value;
displaying a plurality of data points having data values exceeding a predefined threshold in a circular arrangement around and at substantially equal first distances from the first data point; and
displaying the remaining data points in a circular arrangement around and at substantially equal second distances from the first data point;
the second distances greater than the first distances.

28. A method of data visualisation as claimed in any one of claims 25 to 27 wherein each data point represents a website page, the method further comprising the step of displaying relationships representing web traffic between one or more pairs of website pages.

29. A method of data visualisation as claimed in claim 28 further comprising the step of displaying an indicator of web traffic magnitude between pairs of website pages.

30. A data visualisation computer program which enables:
maintaining in a data value memory a finite set of data values;
displaying a representation of each data value centered on respective data points, a plurality of the data points positioned in a circular arrangement;
generating and displaying relationships between one or more pairs of the data points positioned in a circular arrangement.

31. A data visualisation computer program as claimed in claim 30 which further enables displaying a first data point having the highest data value; and displaying the remaining data points in a circular arrangement around the first data point.

32. A data visualisation computer program as claimed in claim 30 which further enables:
displaying a first data point having the highest data value;
displaying a plurality of data points having data values exceeding a predefined threshold in a circular arrangement around and at substantially equal first distances from the first data point; and
displaying the remaining data points in a circular arrangement around and at substantially equal second distances from the first data point;
the second distances greater than the first distances.

33. A data visualisation computer program as claimed in any one of claims 30 to 32 wherein each data point represents a website page, the computer program further enabling displaying relationships representing web traffic between one or more pairs of website pages.

34. A data visualisation computer program as claimed in claim 33 which further enables displaying an indicator of web traffic magnitude between pairs of website pages.

35. A data visualisation computer program as claimed in any one of claims 30 to 34 embodied on a computer-readable medium.
